(19) United States
(12) Patent Application Publication
(10) Pub. No.: US 2016/0357749 A1
(43) Pub. Date: Dec. 8, 2016

(54) ASSOCIATING KEYWORDS FROM COMMUNICATION CONTENT WITH COMMUNICATION PARTICIPANTS

(71) Applicant: International Business Machines Corporation, Armonk, NY (US)

(72) Inventors: Si Bin Fan, Beijing (CN); Peng Hui Jiang, Beijing (CN); Hua Wang, Beijing (CN); Jia Zou, Beijing (CN)

(21) Appl. No.: 14/730,708

(22) Filed: Jun. 4, 2015

(51) Int. Cl. G06F 17/30

(52) U.S. Cl. CPC G06F 17/3053; G06F 17/30867; G06F 17/30554

(57) ABSTRACT

Embodiments of the present invention provide systems, methods, and program products for associating keywords from communication content with communication participants. Embodiments of the present invention can be used to associate communication metadata based, at least in part on one or more keywords extracted from communication content. Embodiments of the present invention can be used to improve message communications by identifying participants, not known to a user, by some other identifier (such as a keyword) based, at least in part, on communication content.

### BACKGROUND

The present invention relates generally to the field of communication data management, and more particularly to metadata extraction and association of communication data.

Mobile devices and teleconferencing systems typically rely on address books of contacts for quick access to telephone numbers and other identity information for communication participants. Generally, in order to add or modify a contact, a user manually inputs changes to the contact information. For example, a user can select an option to add a telephone number to his or her contact list and select specific identifying information (e.g., email, work information) to add to the contact list.

### SUMMARY

Embodiments of the present invention provide systems, methods, and program products for associating keywords from communication content with communication participants. In one embodiment of the present invention, a method is provided comprising: receiving information pertaining to at least a first communication between at least two participants, where the information includes communication content and communication metadata, and where the communication metadata includes identifiers corresponding to each of the respective participants; extracting one or more keywords from the communication content; and associating the extracted keywords with at least one of the participants based, at least in part, on the identifiers of the received communication metadata.

### BRIEF DESCRIPTION OF THE DRAWINGS

FIG. 1 is a block diagram view of a first embodiment of a system, according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is block diagram view of a second embodiment of a system, according to the present invention; and

FIG. 5 is a diagram that is helpful in understanding call record and content record associations, according to the second embodiment system.

### DETAILED DESCRIPTION

Embodiments of the present invention recognize that there are ineffective ways to link content discussed in a phone conversation to the contact information of a person involved in the phone conversation. Typically, phone call participants have to document the details of phone conversations (e.g., name, number, and topic discussed) to recall that information for later use. Embodiments of the present invention provide solutions for analyzing the content of a call, extracting relevant voice metadata, and associating the voice metadata to caller information. In this manner, as discussed in greater detail in this specification, embodiments of the present invention can be used to reference extracted voice metadata to find caller information without a user having to manually document these details. This Detailed Description section is divided into the following sub-sections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

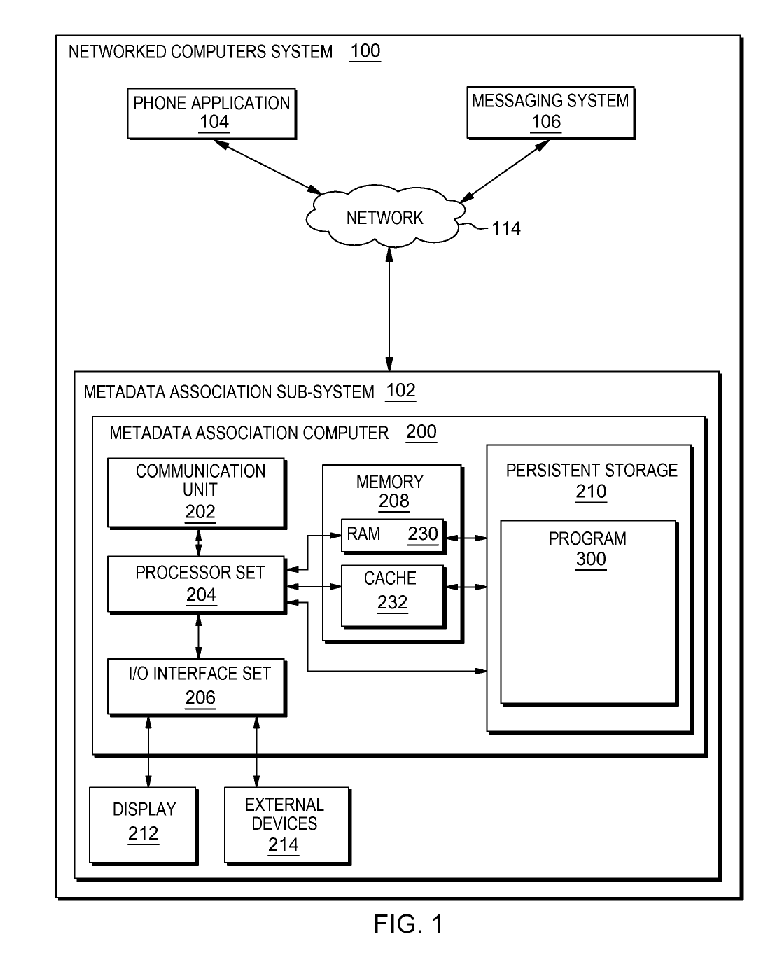

An embodiment of a possible hardware and software environment for software and/or methods according to the present invention will now be described in detail with reference to the Figures. FIG. 1 is a functional block diagram illustrating various portions of networked computers system 100, including: metadata association sub-system 102; phone application 104; messaging system 106; communication network 114; metadata association computer 200; communication unit 202; processor set 204; input/output (I/O) interface set 206; memory device 208; persistent storage device 210; display device 212; external device set 214; random access memory (RAM) devices 230; cache memory device 232; and program 300.

Metadata association sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. EXAMPLE EMBODIMENT

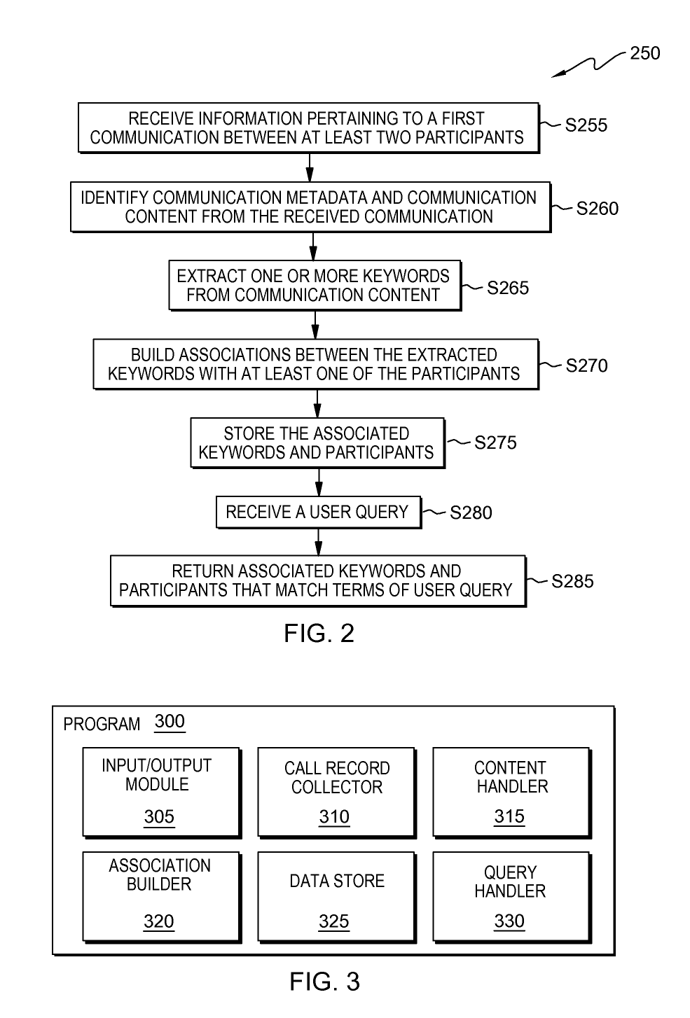

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks). It should be noted that this example embodiment (also referred to in this sub-section as the “present embodiment,” the “present example,” the “present example embodiment,” and the like) is used herein for example purposes, in order to help depict the scope of the present invention. As such, other embodiments (such as embodiments discussed in the Further Comments and/or Embodiments sub-section, below) may be configured in different ways or refer to other features, advantages, and/or characteristics not fully discussed in this sub-section.

In the present example, user a of metadata association sub-system 102 is a project manager monitoring the status of product X. In the process of managing product X, user a has made three phone calls (i.e., phone calls PC₁₋₃) to three different individuals (i.e., individuals A-C) at three different phone numbers, where none of the individuals are stored as contacts on the contact list of user a's phone. Each phone call's participants discussed a different topic with regard to product X. In phone call PC₁ user a and individual A discussed manufacturing problems a manufacturing plant had in producing product X, in phone call PC₂ user a and individual B discussed raw materials needed from a supplier for product X, and in phone call PC₃ user a and individual C discussed transportation details of product X from the plant to an end location. Now, two days later, user a wants to continue a conversation with the supplier but cannot remember which of the three phone numbers belongs to the supplier. For illustrative purposes, the following discussion is made with respect to extracting keywords from a phone conversation and associating the extracted keywords between user a and the supplier (i.e., individual B) for later use, it being understood that the operational steps of FIG. 250 can be performed to extract and associate keywords from phone conversations between any number of participants (e.g., individuals A and C).

Processing begins at operation S255, where call input/output mod 305 receives information pertaining to a first communication between at least two participants. The term “communication”, as used herein, refers to interaction between at least two participants (e.g., a phone call, a text, e-mail, video message, etc.). In this embodiment, the information pertaining to the first communication comprises communication metadata and communication content. The term “communication metadata”, as used herein, refers to any data relating to the communication that is not the actual content of the communication. Examples of communication metadata include, but are not limited to: (i) identifying information of the participants (e.g., the phone number of the caller); (ii) time-related information (e.g. the time of the call, the duration of the call, and frequency with which that number is dialed); (iii) location-related information (e.g. geographic location(s) of the communication's participants); and/or (iv) other metrics used to measure phone use. Conversely, the term “communication content”, as used herein, refers to in the actual content of a communication (see the Definitions sub-section of this Detailed Description). In the present embodiment, call record collector mod 310 receives the information pertaining to the first communication from one or more components of networked computers system 100 (e.g., phone application 104 and messaging system 106).

Processing proceeds to operation 5260, where call record collector mod 310 identifies communication metadata and communication content from the received information pertaining to the first communication. Continuing the above example, call record collector mod 310 identifies the following communication metadata for phone call PC₂: (i) the phone number dialed by user a was 607429XXXX, (ii) the call was initiated on 4-10-2014 at 14:00:01, and (iii) the duration of the call was twenty minutes. Call record collector mod 310 also identifies communication content by its media type (e.g., audio) and transmits the communication content to content handler mod 315.

Processing proceeds to step 265, where content handler mod 315 extracts one or more keywords from the communication content. In the present embodiment, content handler mod 315 receives communication content of phone call PC₂ from call record collector mod 310, converts the audio file associated with PC₂ to text using voice analysis software, parses the text, and extracts one or more keywords. For example, content handler mod 315 can convert the audio file associated with PC₂ to text that reads:
User a: Good morning, my name is Tom Clarkson.
Individual B: Good morning, Copper R Company, this is John Doe speaking.
User a: I am calling to ask for a quote for these raw materials. In short, I would like for you to be our supplier for this project. What is the best price you can give me?
Individual B: Well, I can sell you that for $2.50 per pound.
User a: Great, I'll take 50 pounds.
Individual B: Sure thing, what company should I send the invoice to?
User a: Company X.
Individual B: Ok, that sounds good. May I have an email address to send a confirmation?
User a: Sure, TClarkson@companyX.com
Individual B: Ok great. Is there anything else I can do for you?
User a: No, I'm all set. Have a good day.
Individual B: Ok, you too. Goodbye.
User a: Thanks, bye.

In other embodiments, content handler mod 315 can receive communication content of phone call PC₂ from one or more other components of networked computers system 100 (e.g., phone application 104 and messaging system 106).

In this embodiment, content handler mod 315 parses the text by using natural language annotations (e.g., sentence splitting, tokenization, POS tagging, chunking, dependency parsing, and anaphora resolution, etc.) to process the semantics of the text. For example, content handler mod 315 can use sentence splitting to identify segments of text according to punctuation (e.g., a comma, a period, an exclamation point, a question mark, etc.) in the PC₂ converted text. In other embodiments, content handler mod 315 can extract keywords directly from audio associated with communication content of a phone call using semantic analysis or content analysis techniques.

Once the communication content from PC₂ has been converted into text, content handler mod 315 can then extract keywords from the PC₂ converted text according to weighting and filtering rules. In some embodiments, each word in the communication content is assigned a weight and filtered according to that weight. For example, the word “supply”—which is part of an example communication content—can be assigned a weight based on the frequency with which that word (i.e., supply) is mentioned. After a specified threshold is reached (e.g., ten times mentioned) that word (e.g., supply) can then be identified as a keyword.

In this embodiment, weighting and filtering rules can be configured to any user-defined criteria. For example, the weighting rules can be configured to identify keywords such as company name, supply, names of participants, materials, etc. In this embodiment, filtering rules can specify that conventional greetings should not be assigned weight values. For example, conventional greetings such as “hello”, “hi”, “hey”, “good morning”, “good afternoon”, “good evening”, “goodbye”, “bye”, etc. should not be assigned weight values. Content handler mod 315 can assign point values to each keyword identified, filter out conventional greetings such as “good morning”, “goodbye”, and “bye”, and extract from PC₂ the following keywords: John Doe, Copper R Company, copper, price, supplier, and materials.

In other embodiments, the weighting rules and filtering rules are used to identify keywords not specified by the user. For example, a point value of “1” is assigned to each time a word is mentioned in the phone conversations. Responsive to determining that a word satisfied a specified threshold (e.g., a point value of ten), content handler mod 315 can identify that word as a keyword. For example, where a phone conversation mentions the word “supplier” ten times, content handler mod 315 can identify “supplier” as a keyword.

Processing proceeds to step S270, where association builder mod 320 builds associations between the extracted keywords and at least one of the participants. In this embodiment, association builder mod 320 receives from call record collector mod 310 and content handler mod 315 communication metadata and communication content, respectively, for a phone communication (e.g., phone call PC₂). In the present example embodiment, responsive to receiving communication metadata and communication content of phone call PC₂, association builder mod 320 builds associations between the extracted keywords (i.e., from communication content of phone call PC₂) and the participants of the communications (i.e., from communication metadata of phone call PC₂).

For example, association builder mod 320 can associate (i.e., link) any of the following keywords (e.g., copper, price, supplier, and materials) with communication metadata (e.g., the number dialed as 607429XXXX) for a particular participant, John Doe. Accordingly, the extracted keyword that was identified as a name, “John Doe”, would now be associated with the number 607429XXXX. The extracted keyword “copper” would now be associated (i.e., linked) with the number 607429XXXX, and so on for each of the extracted keywords (e.g., price, supplier, and materials) so that communication metadata (e.g., the number 607429XXXX) can be retrieved by searching for any keyword associated with it. For example, in a later search, a user may only remember what was discussed (e.g., copper) during a phone call. The user can enter a user query via phone application 104 for “copper” and retrieve the associated number 607429XXXX.

The identified keywords can also be associated (i.e., linked) to other communication metadata. For example, the date when the phone conversation transpired can also be associated. Continuing the example above, the extracted keyword that was identified as a name, “John Doe”, would now be associated with a date that the conversation took place (e.g., 04/10/2015). Likewise, the other keywords would also be associated with the date the conversation took place. Thus, in a later search, a user could enter a user query via phone application 104 for “copper AND 4/10/2015” and retrieve the number 607429XXXX.

Processing proceeds to S275, where data store mod 325 stores the associated keywords and participants. In the present embodiment, data store mod 325 stores the metadata associated with the participants received from association builder mod 320. In other embodiments, data store mod 325 can query association builder mod 320 pursuant to a schedule (i.e., at specified intervals) for associated keywords and participants. For example, data store 325 can query association builder mod 320 every hour for new associations. In other embodiments, data store 325 can query association builder 320 at any user-defined time interval. In general, data store mod 325 can be implemented using any storage media known in the art.

Processing proceeds to S280, where input/output module (“mod”) 305 receives a user query from phone application 104. The term “user query”, as used herein, refers to a string of query terms pertaining to a particular subject area that is of interest to the user. In general, phone application 104 can be implemented with any program that transmits user queries to and receives results from input/output mod 305. Messaging system 106 can be implemented using a browser and web portal or any program that transmits search queries to, and receives results from, input/output mod 305. Continuing the above example, input/output mod 305 receives a user query for “suppliers”. In other embodiments, query handler mod 330 can receive a user query from phone application 104. In yet other embodiments, input/output mod 305 and/or query handler mod 330 can receive a user query from one or more other components of networked computers system 100, such as messaging system 106.

In some instances, results can be ordered based on the frequency with which a keyword is used during a phone conversation. In this embodiment, responsive to receiving a user query, query handler mod 330 can assign a weight for each communication (e.g., a phone call, a text, e-mail, video message, etc.) and filter results according to that weight. In other words, the weighting rules, (i.e., those rules that were used to identify keywords) can be used to assign weight values to each communication (e.g., a phone call, a text, e-mail, video message, etc.). For example, a phone conversation assigned a higher weight indicates that communication metadata associated with the phone conversation has a greater likelihood of relevance to a later user query (e.g., because that phone conversation has a keyword mentioned 50 times that matches the terms of a user query). In this embodiment, a numerical weighting scale is used, where lower numbers represent lesser weights and higher numbers represent greater weights. In other embodiments, any desirable weighting scale can be used.

For example, where a user specifies that supply, names of participants, and materials are important keywords, content handler mod 315 can identify and assign point values to the conversation each time a supply, a name of a participant, and/or a material is identified in that particular conversation. A phone conversation assigned a higher weight for a particular keyword indicates that the phone conversation would be a better match for that keyword. For example, between two phone calls (phone calls 1 and 2), call 1 may mention the keyword “supply” three times whereas call 2 may mention the keyword two times. Accordingly, call 1 would receive the higher weight for “supply”. In this embodiment, a numerical weighting scale is used, where lower numbers represent lesser weights and higher numbers represent greater weights. In other embodiments, any desirable weighting scale can be used.

Processing proceeds to operation S285, where input/output mod 305 returns associated keywords and participants that match one or more terms of the user query. In this embodiment, input/output mod 305 calls association builder mod 320 to search associated keywords and participants that match one or more terms of the user query. Continuing the above example, input/output mod 305 calls association builder mod 320 to retrieve associated keywords and participants that match one or more terms of the user query. In this example, association builder mod 320 identifies a participant (by its phone number, 607429XXXX) as being associated with the user query (e.g., supplier). Input/output mod 305 can then transmit information pertaining to the associated participant to phone application 104.

Where more than one keyword is associated with different communication metadata, association builder mod 320 uses weighting and filtering rules (i.e., the weighting and filtering rules used to assign weights to phone conversations, as previously discussed) to rank communication metadata and return communication metadata (e.g., a phone number that matches a user query) in order of relevancy. For example, a weighting and filtering rule can be configured such that each time a keyword is mentioned, a corresponding point value is assigned to that phone conversation. A phone conversation assigned a higher weight for a particular keyword indicates that the phone conversation would be more relevant and thus displayed higher in a result returned to the user. For example, phone conversations PC_{A} and PC_{B} are both associated with a keyword “supply”. Content association builder mod 320 can identify from the parsed transcript of the conversation in PC_{A} that the keyword “supply” was mentioned ten times, whereas the conversation in phone conversation PC_{B} only mentioned the keyword “supply” once. Accordingly, phone conversation PC_{A} would receive the higher weight for “supply” and be ranked higher than phone conversation PC_{B}.

In another embodiment, content association builder mod 320 can access communication metadata to identify timestamps of respective phone calls that contain keywords that match a user query and display results (e.g., phone numbers that match a user query) in order of most recent calls. For example, between two phone conversations PC_{A} and PC_{B} that match a user query for “supplier”, content association builder mod 320 can access communication metadata and identify that phone conversation PC_{A} took place last night at 2200 hours while phone conversation PC_{B} took place over a month ago at 1700 hours. Accordingly, content association builder mod 320 displays phone conversation PC_{A} higher in a result returned to the user.

In other embodiments, a phone conversation may be assigned a higher weight for particular keywords based, at least in part, on the duration of the phone call. For example, phone calls PC_{A} and PC_{B} are both associated with a keyword “supply”. Content association builder mod 320 can identify from the communication metadata of phone conversation PC_{A} that the duration of phone conversation PC_{A} was over 50 minutes. Content association builder mod 320 can further identify that the keyword “supply” was mentioned twenty times from the parsed transcript of the communication content of phone conversation PC_{A}. Furthermore, content association builder mod 320 can identify that the communication content of phone conversation PC_{B} only mentioned the keyword “supply” once for a period of two minutes. Accordingly, phone conversation PC_{A} would receive the higher weight and be ranked higher than phone conversation PC_{B}. As mentioned before, in this embodiment, a numerical weighting scale is used, where lower numbers represent lesser weights and higher numbers represent greater weights. In other embodiments, any desirable weighting scale can be used.

Accordingly, in this embodiment, communication metadata and communication content are associated based, at least in part, on one or more keywords extracted from the communication content. Associating communication metadata and communication content can improve message communications by identifying participants, not known to a user, by some other identifier (such as a keyword) based, at least in part, on the communication content.

### III. FURTHER COMMENTS AND/OR EMBODIMENTS

Some embodiments of the present invention recognize the following facts, potential problems and/or potential areas for improvement with respect to the current state of the art: (i) current methods for associating call content discussed in telephone communications to an associated contact person are ineffective; (ii) there are no solutions for tagging call history with keywords identified from a voice call; and/or (iii) in managing call history, there currently does not exist a solution to analyze content of each call, extract relevant keywords, and tag call records so as to facilitate later use of these phone records.

Some embodiments of the present invention may include one, or more, of the following features, characteristics and/or advantages: (i) identifying relationships between a contact person and call content; (ii) identifying contact information based, at least in part on a topic discussed in a previous conversation; (iii) identifying a contact person's topic of interest from call content; (iv) identifying topics that a contact person may be sensitive to, thereby avoiding those topics in future conversations; (v) identifying a direct relationship between a call record and call content; (vi) enabling a mobile user to find associated call content by typing or speaking a keyword; (vii) associating any kind of content with a call word according to pre-defined rules; (viii) evaluating weight of associations according to attributes (e.g., time, contact information, topics, and keywords) of a call record and keywords captured in call content; (ix) analyzing content wherein the content comprises textual, audio, and video content; (x) building complex associations between a call record and call content based on simple association (i.e., exploiting other associations based on existing associations); (xi) allowing consumers to use call records of a mobile phone, analyze the recording content of each call, and extract relevant keywords which can be marked with a call record so as to facilitate the user to use these phone records in a meaningful way; and/or (xiii) using voice recognition and analysis techniques of call records to extract relevant keywords and corresponding derivative terms of call records that can be associated with personal phone records and used by consumers.

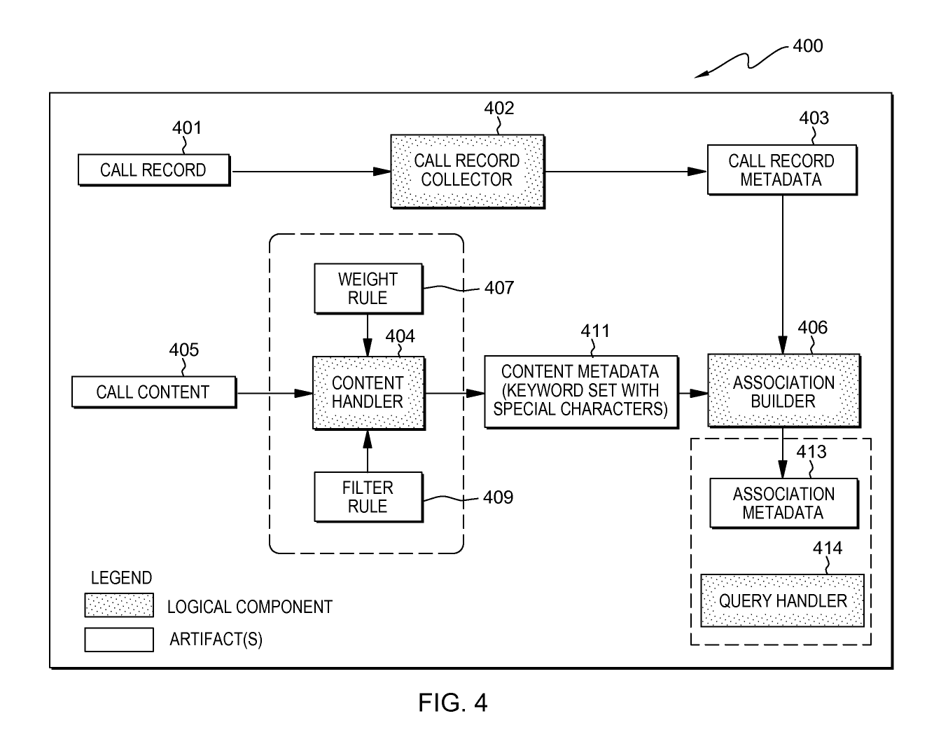

FIG. 4 includes block diagram view 400 of a second embodiment of a system, according to the present invention. The term “call content”, as used herein, refers to a specific type of communication content relating to audio/voice information. In this embodiment, content handler 404 receives call content 405 and extracts relevant content metadata (see the Definitions subsection of this Detailed Description) contained in call content 405, according to weight rule 407 and filter rule 409, and generates content metadata 411. In this embodiment, weight rule 407 and filter rule 409 can be user-defined and based, at least in part on content or rules the user is interested in or wants to identify in phone conversations.

In some instances, call content 405 may have associated “special metadata” (i.e., metadata embedded in call content 405). In such instances, content handler 404 can identify keywords in call content 405 that have special metadata. In this embodiment, special metadata can be used to describe an identified keyword using the following syntax: {keyword1, {att1a, att1b, att1c}}, {keyword2, {att2a, att2b, att2c}}, {keyword3, {att3a, att3b, att3c}}, and so on.

In this instance, the term(s) “att1a-c”, refers to attributes that are examples of special metadata. For example, three keywords “supply”, “price”, and “Beijing” could be identified as having special metadata that content handler 404 can identify and classify as {supply, {3 (frequency), 10 (offset of first occurrence of keyword), sensitive}}, {price, {1 (frequency), 100 (offset of first occurrence of keyword), sensitive}}, {Beijing, {2 (frequency), 139 (offset of first occurrence of keyword), not sensitive}}}.

In some embodiments of the present invention, call record collector 402 receives call record 401. Call record collector 402 extracts relevant call record information and generates call record metadata 403. The term “call record” (also referred to as “communication metadata” and “communication record”), as used herein, refers to basic call information that comprises, identifying information of the participants (e.g., the number of the caller) and other metrics used to track phone use (e.g., the time of call, the duration of the call, and geographic information as to where the call was placed).

In an embodiment of the present invention, association builder 406 receives call record metadata 403 from call record collector 402 and content metadata 411 from content handler 404. Association builder 406 then builds associations between call record metadata 403 and content metadata 411, yielding association metadata 413. For example, an association builder 406 can receive call record metadata 403 for call record entry 1 (e.g., name of person A and number of person A) and content metadata 411 for call content entry 1 (e.g., express delivery) and associate call record metadata 403 for entry 1 with content metadata 411 for call content entry 1 (e.g., name and number of person A is now associated with the keyword(s) “express delivery”).

In this embodiment, query handler 414 can receive a user query for associated metadata. For example, query handler 414 can receive a request for “express delivery”. Responsive to receiving a user query (e.g., for express delivery), query handler 414 can access association metadata 413 and retrieve associated metadata that matches the user query. For example, query handler 414 can then search stored associated metadata that matches the request for “express delivery”, find the name and number of person A associated with “express delivery”, and return the name and number of person A to the user. In other embodiments, association builder 406 searches association metadata 413 responsive to receiving a user query and returns the associated metadata responsive to a user request.

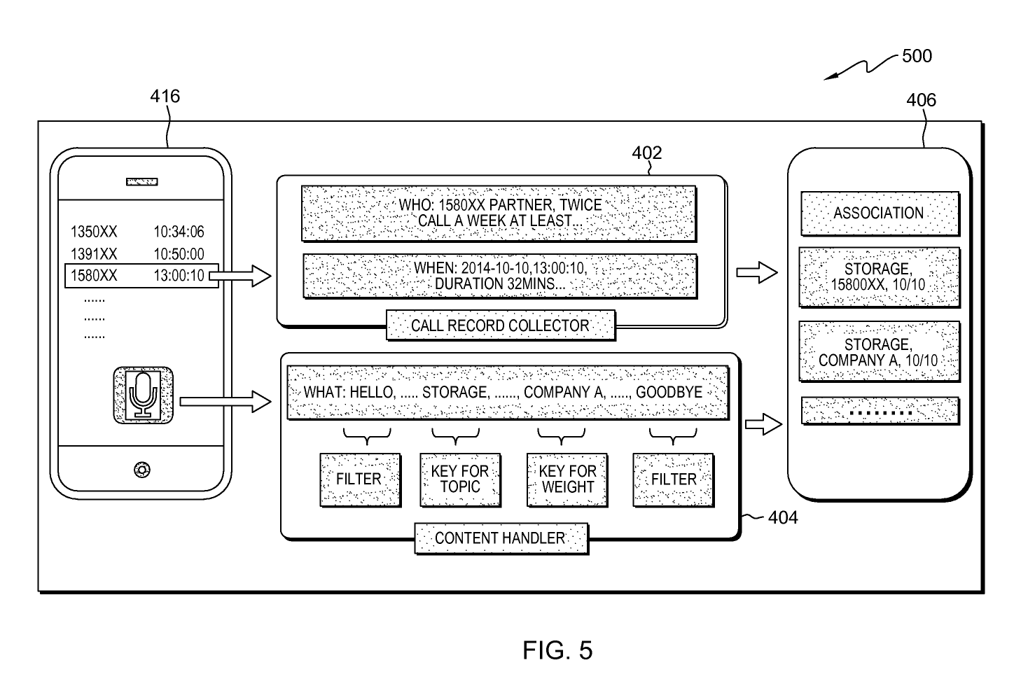

FIG. 5 includes diagram 500 that is helpful in understanding call record and content record associations, according to the second embodiment system. Call record collector 402 is shown receiving a call record from phone application 416. In this embodiment, phone application 416 is depicted as a cellular device. Call record collector 402 is depicted as identifying call record metadata (also referred to as communication metadata in FIG. 2) from a received call. The call record metadata is shown as (i) identifying information of the participants (e.g., the number of the caller) and (ii) time-related information (e.g., the time of the call as, the duration of the call, and frequency with which that number is dialed). In this example, the identifying information of the participants is shown by the number 1580XX and the title of a participant, shown as “Partner”. The time-related information is shown as “2014-10-10” as the date, “13:00:10” as the time the call was placed, “32 minutes” as the duration of the call, and “twice call a week at least” as the frequency.

Content handler 404 is depicted as generating and extracting metadata from the call content record (also referred to as communication content in FIG. 2). In this embodiment, content handler 404 is shown as using voice recognition software to parse a transcript of a conversation. As shown, content handler 404 parses the transcript to identify the following segments: Hello . . . Storage . . . Company A . . . and Goodbye. According to a filtering rule, content handler 404 filters out the word “hello” and “goodbye” as a greeting conventions. Content handler 404 identifies the word “storage” and “Company A” as keywords.

Association builder 406 is depicted receiving call record metadata and call content metadata and building associations between the identified call record metadata and call content record metadata which can later be searched by a user of metadata association system. As shown, the keyword “storage” and “Company A” are associated with call record metadata (e.g., the number “1580XX”).

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Communication: any interaction between at least two participants. For example, a communication can take the form of a phone call, an in-person conversation between at least two people, a text message, an e-mail, and/or a video message.

Communication content: any content discussed in a communication. For example, in audio communications (e.g., phone calls, conference calls, etc.) communication content can be recorded audio between at least two participants in the phone conversation. In text communications (e.g., text messages, e-mail, etc.), communication content can be the text between at least two participants. In video communications (e.g., video messages), communication content can be the recorded audio and/or the recorded video between at least two participants in the video message.

Communication metadata: refers to any data relating to the communication that is not the actual content of the communication. Examples of communication metadata include, but are not limited to: (i) identifying information of the participants (e.g., the number of the caller); (ii) time-related information (e.g. the time of the call, the duration of the call, and frequency with which that number is dialed); (iii) location-related information (e.g. geographic location(s) of the communication's participants); and/or (iv) other metrics used to measure phone use.

What is claimed is:

1. A method comprising:
receiving, by one or more computer processors, information pertaining to at least a first communication between at least two participants, where the information includes communication content and communication metadata, and where the communication metadata includes identifiers corresponding to each of the respective participants;
extracting, by one or more computer processors, one or more keywords from the communication content; and
associating, by one or more computer processors, the extracted keywords with at least one of the participants based, at least in part, on the identifiers of the received communication metadata.

2. The method of claim 1, further comprising:
responsive to receiving a query, returning as a result, by one or more computer processors, information identifying one or more participants associated with the query, based, at least in part, on the one or more participants' respectively associated keywords.

3. The method of claim 2, wherein returning as a result, by one or more computer processors, information identifying one or more participants associated with the query, based, at least in part, on the one or more participants' respectively associated keywords comprises:
accessing, by one or more computer processors, the associated keywords;
determining, by one or more computer processors, that a first associated keyword is relevant to the received query based, at least in part, on an assigned weighted value; and
displaying, by one or more computer processors, information identifying one or more participants associated with the first associated keyword.

4. The method of claim 2, wherein returning as a result, by one or more computer processors, information identifying one or more participants associated with the query, based, at least in part, on the one or more participants' respectively associated keywords comprises:
accessing, by one or more computer processors, the information identifying the one or more participants;
ranking, by one or more computer processors, the one or more participants; and
displaying, by one or more computer processors, the information identifying the one or more participants associated with the query in an order corresponding to the participants' respective ranks.

5. The method of claim 4, wherein ranking, by one or more computer processors, the one or more participants comprises:
assigning, by one or more computer processors, an order to the one or more participants based, at least in part, on timestamps included in the communication metadata of the participants' respective communications.

6. The method of claim 4, wherein ranking, by one or more computer processors, the one or more participants comprises:
assigning, by one or more computer processors, weighted values to the participant's respective communications.

7. The method of claim 6, wherein assigning, by one or more computer processors, weighted values to the participant's respective communications comprises:
parsing, by one or more computer processors, the received communication content into a plurality of words and/or phrases;
counting, by one or more processors, a number of times a first word and/or phrase is included in the parsed communication content; and
on condition that the counted number of times the first word and/or phrase is included in the parsed communication content is greater than a predetermined threshold, extracting, by one or more processors, the first word and/or phrase as a keyword.

8. A computer program product comprising:
one or more computer readable storage media and program instructions stored on the one or more computer readable storage media, the program instructions comprising:
program instructions to receive information pertaining to at least a first communication between at least two participants, where the information includes communication content and communication metadata, and where the communication metadata includes identifiers corresponding to each of the respective participants;
program instructions to extract one or more keywords from the communication content; and
program instructions to associate the extracted keywords with at least one of the participants based, at least in part, on the identifiers of the received communication metadata.

9. The computer program product of claim 8, wherein the program instructions stored on the one or more computer readable storage media further comprise:
program instructions to, responsive to receiving a query, return, as a result, information identifying one or more participants associated with the query, based, at least in part, on the one or more participants' respectively associated keywords.

10. The computer program product of claim 9, wherein the program instructions to return, as a result, information identifying one or more participants associated with the query, based, at least in part, on the one or more participants' respectively associated keywords comprise:
program instructions to access the associated keywords;
program instructions to determine that a first associated keyword is relevant to the received query based, at least in part, on an assigned weighted value; and
program instructions to display information identifying one or more participants associated with the first associated keyword.

11. The computer program product of claim 9, wherein the program instructions to return, as a result, information identifying one or more participants associated with the query, based, at least in part, on the one or more participants' respectively associated keywords comprise:
program instructions to access the information identifying the one or more participants;
program instructions to rank the one or more participants; and
program instructions to display the information identifying the one or more participants associated with the query in an order corresponding to the participants' respective ranks.

12. The computer program product of claim 11, wherein the program instructions to rank the one or more participants comprise:
program instructions to assign an order to the one or more participants based, at least in part, on timestamps included in the communication metadata of the participants' respective communications.

13. The computer program product of claim 11, wherein the program instructions to rank the one or more participants comprise:
program instructions to assign weighted values to the participant's respective communications.

14. The computer program product of claim 13, wherein the program instructions to assign weighted values to the participant's respective communications comprise:
program instructions to parse the received communication content into a plurality of words and/or phrases;
program instructions to count a number of times a first word and/or phrase is included in the parsed communication content; and
program instructions to, on condition that the counted number of times the first word and/or phrase is included in the parsed communication content is greater than a predetermined threshold, extract the first word and/or phrase as a keyword.

15. A computer system comprising:
one or more computer processors;
one or more computer readable storage media; and
program instructions stored on the one or more computer readable storage media for execution by at least one of the one or more computer processors, the program instructions comprising:
program instructions to receive information pertaining to at least a first communication between at least two participants, where the information includes communication content and communication metadata, and where the communication metadata includes identifiers corresponding to each of the respective participants;
program instructions to extract one or more keywords from the communication content; and
program instructions to associate the extracted keywords with at least one of the participants based, at least in part, on the identifiers of the received communication metadata.

16. The computer system of claim 15, wherein the program instructions stored on the one or more computer readable storage media further comprise:
program instructions to, responsive to receiving a query, return, as a result, information identifying one or more participants associated with the query, based, at least in part, on the one or more participants' respectively associated keywords.

17. The computer system of claim 16, wherein the program instructions to return, as a result, information identifying one or more participants associated with the query, based, at least in part, on the one or more participants' respectively associated keywords comprise:
program instructions to access the associated keywords;
program instructions to determine that a first associated keyword is relevant to the received query based, at least in part, on an assigned weighted value; and
program instructions to display information identifying one or more participants associated with the first associated keyword.

18. The computer system of claim 16, wherein the program instructions to return, as a result, information identifying one or more participants associated with the query, based, at least in part, on the one or more participants' respectively associated keywords comprise:
program instructions to access the information identifying the one or more participants;
program instructions to rank the one or more participants; and
program instructions to display the information identifying the one or more participants associated with the query in an order corresponding to the participants' respective ranks.

19. The computer system of claim 18, wherein the program instructions to rank the one or more participants comprise:
program instructions to assign weighted values to the participant's respective communications.

20. The computer system of claim 19, wherein the program instructions to assign weighted values to the participant's respective communications comprise:
program instructions to parse the received communication content into a plurality of words and/or phrases;
program instructions to count a number of times a first word and/or phrase is included in the parsed communication content; and
program instructions to, on condition that the counted number of times the first word and/or phrase is included in the parsed communication content is greater than a predetermined threshold, extract the first word and/or phrase as a keyword.
